(19) United States
(12) Patent Application Publication
(10) Pub. No.: US 2020/0411876 A1
(43) Pub. Date: Dec. 31, 2020

(54) NONAQUEOUS ELECTROLYTE SECONDARY BATTERY AND METHOD FOR PRODUCING SAME

(71) Applicant: Panasonic Intellectual Property Management Co., Ltd., Osaka (JP)

(72) Inventors: JUN KUMAGAI, Osaka (JP); TOMOHIRO UEDA, Osaka (JP); YUYA ASANO, Osaka (JP)

(21) Appl. No.: 16/979,530

(22) PCT Filed: Feb. 28, 2019
(86) PCT No.: PCT/JP2019/007739

§ 371 Date: Sep. 10, 2020

(30) Foreign Application Priority Data
Mar. 15, 2018 (JP) 2018-048512

(51) Int. Cl. H01M 4/62; H01M 4/66; H01M 4/04

(52) U.S. Cl. CPC H01M 4/623; H01M 2004/027; H01M 4/0416; H01M 4/666

(57) ABSTRACT

A nonaqueous electrolyte secondary battery including a battery case; and an electrode assembly and a nonaqueous electrolyte, housed in the battery case. The electrode assembly includes a positive electrode, a negative electrode, and a separator interposed between the positive electrode and the negative electrode. At least one of the positive electrode and the negative electrode includes a material mixture layer including an active material and a binder, and a current collector holding the material mixture layer. The binder contains a first resin and a second resin. The first resin is a fluorocarbon resin. The second resin is a copolymer of a styrene monomer unit and a (meth)acrylic acid monomer unit.

### TECHNICAL FIELD

The present invention relates to a nonaqueous electrolyte secondary battery.

### BACKGROUND ART

In general, an electrode of a nonaqueous electrolyte secondary battery includes a binder for improving biding property between an active material and a current collector or between active materials.

For example, PTL 1 discloses a lithium ion battery including a negative electrode material mixture containing a binder in a mass percentage of 2% or less. The binder includes a polymer including a styrene monomer, an acrylic ester monomer, and an acrylic acid monomer.

PTL 2 discloses a nonaqueous electrolyte secondary battery including a negative electrode material mixture containing, as a binder, a polyolefin thermoplastic resin, and a thermosetting resin of a copolymer of at least one selected from acrylonitrile, styrene, methacrylic acid ester and acrylic ester and butadiene as a binder, and heat-treated at a temperature of not less than a melting point of the thermoplastic resin.

### CITATION LIST

### Patent Literature

PTL 1: Japanese Patent Application Unexamined Publication No. 2016-91987

PTL 2: Japanese Patent Application Unexamined Publication No. 2006-286285

### SUMMARY OF THE INVENTION

When a nonaqueous electrolyte secondary battery is to be provided using each binder disclosed in PTLs 1 and 2, an active material easily falls off when an electrode is bent.

In view of the above, a first aspect of the present invention relates to a nonaqueous electrolyte secondary battery including a battery case; and an electrode assembly and a nonaqueous electrolyte, housed in the battery case. The electrode assembly includes a positive electrode, a negative electrode, and a separator interposed between the positive electrode and the negative electrode. At least one of the positive electrode and the negative electrode includes a material mixture layer including an active material and a binder, and a current collector holding the material mixture layer. The binder includes a first resin and a second resin. The first resin is a fluorocarbon resin, and the second resin is a copolymer of a styrene monomer unit and a (meth)acrylic acid monomer unit.

A second aspect of the present invention relates to a method for producing a nonaqueous electrolyte secondary battery. The method includes: preparing a positive electrode and a negative electrode; preparing an electrode assembly including the positive electrode, the negative electrode, and a separator interposed between the positive electrode and the negative electrode; and housing the electrode assembly together with a nonaqueous electrolyte into a battery case. At least one of the positive electrode and the negative electrode includes a material mixture layer including an active material and a binder, and a current collector holding the material mixture layer. The binder includes a first resin and a second resin. The first resin is a fluorocarbon resin, and the second resin is a copolymer of a styrene monomer unit and a (meth)acrylic acid monomer unit. The method further includes heating the positive electrode and/or the negative electrode.

The present invention can suppress falling-off of the active material from the electrode of the nonaqueous electrolyte secondary battery.

### BRIEF DESCRIPTION OF THE DRAWINGS

FIG. 1 is an image diagram of an electrode of a nonaqueous electrolyte secondary battery in accordance with an exemplary embodiment of the present invention.

FIG. 2 is a partially cut-away plan view of a film exterior body of the nonaqueous electrolyte secondary battery in accordance with the exemplary embodiment of the present invention.

FIG. 3 is a sectional view taken on line III-III of the nonaqueous electrolyte secondary battery shown in FIG. 2.

### DESCRIPTION OF EMBODIMENTS

The nonaqueous electrolyte secondary battery according to the present invention includes an electrode assembly including a positive electrode, a negative electrode, and a separator interposed therebetween, and a nonaqueous electrolyte. The electrode assembly and the nonaqueous electrolyte are housed in a battery case. At least one of the positive electrode and the negative electrode includes a material mixture layer including an active material and a binder, and a current collector holding the material mixture layer. The binder contains a first resin and a second resin. The first resin is a fluorocarbon resin. The second resin is a copolymer of a styrene monomer unit and a (meth)acrylic acid monomer unit.

The fluorocarbon resin (=fluororesin) as the first resin is a generic name of polymers including a monomer unit including fluorine, and is preferably a fluorocarbon resin in which a component obtained by polymerizing olefin including fluorine accounts for 90% by mass or more. For example, poly vinylidene difluoride (hereinafter, referred to as “PVDF”) can be used. Herein, 90% by mass or more of PVDF may include a vinylidene fluoride unit.

As the fluorocarbon resin, PVDF is preferably used, but polyvinyl fluoride, polytetrafluoroethylene, polychlorotrifluoroethylene, a perfluoroalkoxy fluorine resin, tetrafluoroethylene-hexafluoropropylene copolymer, and the like, may be used. These may be used singly or in combination of two or more.

The styrene monomer unit constituting the second resin is a monomer unit derived from a styrene monomer. The styrene monomer is a monomer having a styrene structure, as a basic structure, in which one of hydrogen atoms of benzene is substituted with a vinyl group. For example, 90% by mole or more of the styrene monomer unit may be a styrene unit.

The (meth)acrylic acid monomer unit constituting the second resin is a monomer unit derived from a (meth)acrylic acid monomer. The (meth)acrylic acid monomer is a monomer including acrylic acid, methacrylic acid, acrylic acid derivatives or methacrylic acid derivatives as a basic structure. Hereinafter, acrylic acid and methacrylic acid are genetically called as (meth)acrylic acid.

Specific examples of the (meth)acrylic acid monomer include (meth)acrylic acid, (meth)acrylic ester, and the like. Specific examples of the (meth)acrylic ester include methyl (meth)acrylate, ethyl (meth)acrylate, propyl (meth)acrylate, butyl (meth)acrylate, and the like.

Use of the first resin and the second resin in combination as the binder can enhance the effect of suppressing falling-off of the active material when the electrode is bent, while sufficient flexibility is given to the material mixture layer. That is, the bending resistance of the electrode is remarkably improved. When one of the first resin and the second resin is used, it is difficult to suppress falling-off of the active material when the electrode is bent. When the active material falls off from the electrode, desired battery characteristics cannot be obtained, and a short circuit between the positive electrode and the negative electrode easily occurs.

The reason why the bending resistance of the electrode is remarkably improved is assumed as follows.

The second resin has the advantages of high heat resistance and high adhesive strength. However, when only the second resin is used for the binder, the adhesive strength is excessively strong and the electrode tends to be rigid. When a rigid electrode is bent, crack easily occurs in the material mixture layer, and the active material easily falls off.

The first resin is advantages of having small particle size so that it is easily dispersed in the material mixture layer, in addition to having excellent flexibility. When the first resin and the second resin are mixed with each other, the first resin having a smaller particle size enters between the second resins having a larger particle size. That is to say, the first resin having high flexibility has a function of relieving the bending stress in the surrounding of the second resin. Thus, the flexibility of the first resin is incorporated into the second resin without changing advantageous physical properties of the second resin itself, so that the bending resistance of the electrode is remarkably improved.

Furthermore, use of the first resin and the second resin in combination is also advantageous in relieving warping of the electrode. Many of the causes of warping are uneven distribution of the mixture layer existing on both sides of the current collector. The electrode is manufactured through rolling the material mixture layer, but warping easily occurs in the electrode due to the rolling. For example, when an amount of the material mixture layers applied are uneven between a material mixture layer on one side (front side) of the current collector and a material mixture layer on the other side (back side) of the current collector, a difference occurs in the degree of elongation of the material mixture layer at the time of rolling. The warping of the electrode causes positional displacement between the electrodes when an electrode assembly is formed, causing the internal short circuit. Such a warping is relieved by heating the material mixture layer so as to soften the first resin.

The reason why the warping of the electrode is relieved is assumed as follows.

The first resin has a low melting point. For example, PVDF has a melting point of about 140° C. Therefore, when the electrode is heated, the first resin is softened. It is considered that when the first resin is softened, active materials move such that stress of the active materials is relieved while a strong bonding state by the second resin is maintained.

In view of the above, the method for producing a nonaqueous electrolyte secondary battery according to the present invention includes preparing a positive electrode and a negative electrode; preparing an electrode assembly; and housing the electrode assembly together with a nonaqueous electrolyte into a battery case. The method further includes heating the positive electrode and/or the negative electrode. By the heating of the positive electrode and/or the negative electrode, warping of the positive electrode and/or the negative electrode in the final stage can be corrected.

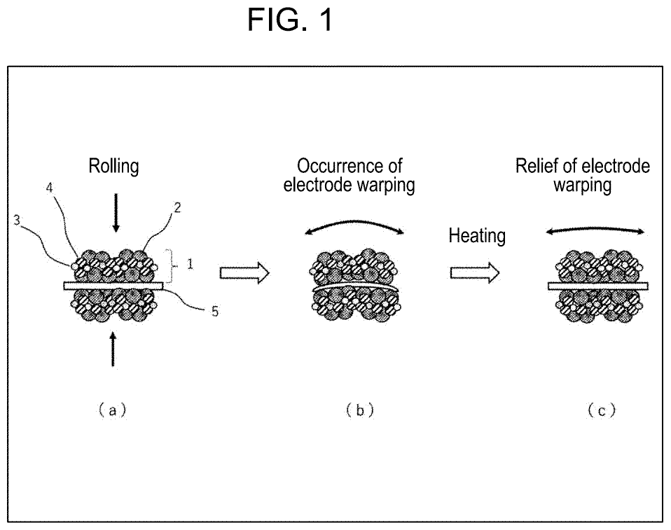

FIG. 1 shows an image diagram of an electrode included a nonaqueous electrolyte secondary battery in accordance with this exemplary embodiment. As shown in FIG. 1(a), material mixture layer 1 including active material 2, first resin 3, and second resin 4 is formed on a surface of current collector 5. First resin 3 has good dispersibility, and is dispersed in gaps of neighboring second resins 4. Therefore, by allowing first resin 3 having high flexibility to present in the surrounding of second resin 4 having strong adhesive strength, bending stress is relieved.

As shown in FIG. 1(a), in general, material mixture layer 1 is rolled in order to increase the capacity density of the battery, but the elongation rate at the time of compression of material mixture layer 1 differs due to a difference in thickness between the material mixture layer of current collector 5 on one side (front side) and the material mixture layer of current collector 5 on the other side (back side). Consequently, warping occurs in the electrode (FIG. 1(b)). The warping of the electrode is relieved by heating the material mixture layer after the material mixture layer is compressed (FIG. 1(c)). At this time, as shown in FIG. 1(c), arrangement of active material 2, first resin 3, and second resin 4 is moved.

An amount of the binder included in the material mixture layer is preferably 3 to 5 parts by mass with respect to 100 parts by mass of the active material. Thus, excellent battery characteristics are easily secured and the bending resistance of the electrode is easily improved.

The amount of the second resin is preferably 50 to 150 parts by mass, more preferably 60 to 140 parts by mass, and further preferably 80 to 120 parts by mass with respect to 100 parts by mass of the first resin. When the amount of the second resin with respect to first resin 100 parts by mass is 50 to 150 parts by mass (a mass ratio of the first resin to the second resin is made to be 50% to 150%), the bending resistance of the electrode is easily enhanced while excellent battery characteristics are secured.

In the nonaqueous electrolyte secondary battery of this exemplary embodiment, at least one of the positive electrode and the negative electrode may include a material mixture layer including an active material and a binder. However, in general, the negative electrode expands and contracts according to charge and discharge more than the positive electrode, falling-off of the active material tends to occur by a charge and discharge cycle. Therefore, the material mixture layer of at least the negative electrode preferably includes the above binder.

The electrode assembly may be a laminate in sheet form obtained by laminating a positive electrode in sheet form and a negative electrode in sheet form, respectively. Electrodes in sheet form are suitable to be laminated to form an electrode group in sheet form. When the electrode group in sheet form is formed, if warping occurs in the positive electrode or the negative electrode, position displacement tends to occur in laminating. Therefore, use of the positive electrode and the negative electrode of this exemplary embodiment can suppress occurrence of warping and considerably reduce the process defect rate.

Furthermore, the electrode assembly is preferably laminated such that the negative electrodes are disposed to the both outer surfaces of the laminate in sheet form. On the outer surface of the negative electrode, the material mixture layer may be formed on a surface facing the positive electrode, that is, only one of the surfaces of the current collector. Usually, when a material mixture layer is formed only on one surface of the current collector, warping easily occurs. However, when the positive electrode and/or the negative electrode is heated, such warping can be solved.

When the battery case is formed of a film exterior body, by enhancing the bending property of the electrode assembly, a flexible battery having high reliability can be provided. A total thickness of the battery may be 2 mm or less, or 1 mm or less. For the film exterior body, for example, it is possible to use a laminate film including a gas barrier layer having gas barrier property, a seal layer laminated on one surface of the gas barrier layer, and a protective layer laminated on the other surface of the gas barrier layer. Thus, durability and handling property of the film exterior body are improved. The gas barrier layer is preferably an aluminum foil or an aluminum alloy foil because it is easily produced and has excellent flexibility. The protective layer preferably includes at least one selected from the group consisting of polyolefin, polyamide, and polyester. This improves the chemical resistance of the film exterior body. The seal layer preferably includes polyolefin. This also makes it easy to attach the seal layer to the film exterior body by thermal welding.

Next, a method for producing a nonaqueous electrolyte secondary battery of this exemplary embodiment is described.

This exemplary embodiment allows the current collector to hold the material mixture layer, and then carries out heating of the positive electrode and/or the negative electrode. In general, the electrode is obtained by applying paste including a material mixture as a precursor of the material mixture layer on a current collector to obtain a coating film, then drying the coating film, and then rolling the coating film to thus form a material mixture layer. At the time of rolling, usually, warping of the electrode occurs. On the contrary, when s first resin and a second resin are used in combination as a binder to be used for the material mixture layer, by heating the positive electrode and/or the negative electrode after rolling, the first resin is softened, and the active material moves such that stress between the active materials is relieved, so that the warping of the electrode can be relieved.

The heating of the positive electrode and/or the negative electrode may carry out heating, for example, at a temperature of 120° C. to 160° C. for 0.02 minutes to 1 minute. This can correct warping of the electrode, and can considerably reduce the process defect rate. Note here that any one of the positive electrode and the negative electrode may be subjected to heating. However, there is no particular problem even when both the positive electrode and the negative electrode are subjected to heating.

Paste using a fluorocarbon resin generally uses an organic solvent as a dispersion medium. For the organic solvent, N-methyl-2-pyrrolidone (hereinafter, referred to as “NMP”) and the like, capable of dissolving a fluorocarbon resin, is used. However, from the viewpoint of simplifying manufacturing facility, it is preferable to use a water medium as the dispersion medium. Specifically, it is preferable that paste including a binder and an active material and water (hereinafter, referred to as “aqueous paste”) is held by the current collector, and then dried to obtain a material mixture layer.

In the aqueous paste, since the first resin is granulated and dispersed in water, binding strength of the binder tends to be lowered. On the other hand, when the first resin and the second resin are used in combination as the binder, since the effect of the second resin is expressed in addition to the effect of the first resin, high binding strength is obtained.

Hereinafter, an example of a nonaqueous electrolyte secondary battery including a film exterior body in accordance with one embodiment of the present invention is described with reference to the drawings. However, the present invention is not necessarily limited to the following Examples.

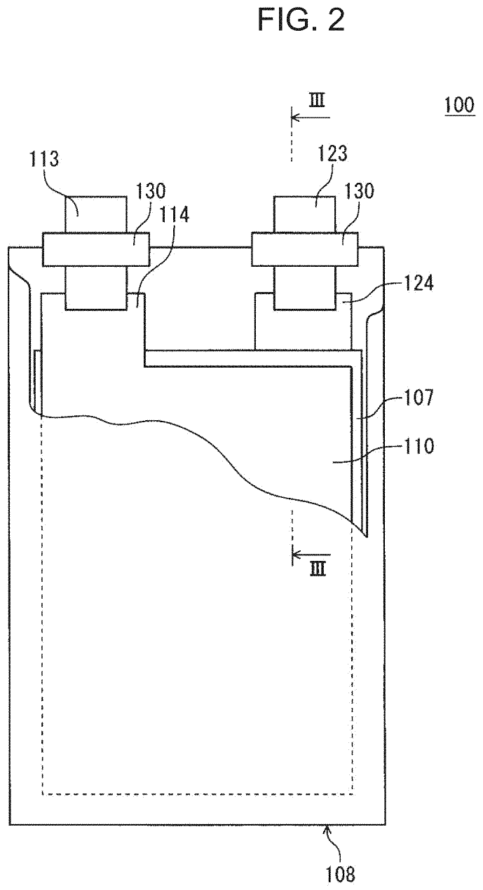

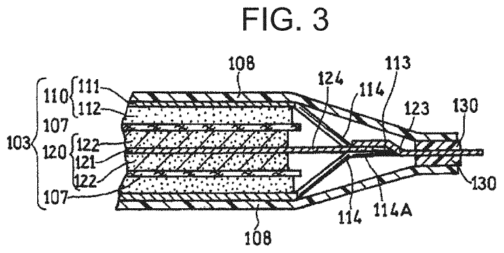

FIG. 2 is a partially cut-away plan view of a film exterior body of a nonaqueous electrolyte secondary battery in accordance with this exemplary embodiment. FIG. 3 is a sectional view taken on line III-III of the nonaqueous electrolyte secondary battery.

Nonaqueous electrolyte secondary battery 100 includes electrode assembly 103, a nonaqueous electrolyte (not shown), and film exterior body 108 housing thereof. Electrode assembly 103 includes a pair of first electrodes 110 positioned at the outer sides, second electrode 120 disposed between first electrodes 100, and separator 107 interposed between first electrode 110 and second electrode 120. First electrode 110 includes first current collector 111 and first material mixture layer 112 attached to one surface of first current collector 111. Second electrode 120 includes second current collector 121 and second material mixture layer 122 attached to both surfaces of second current collector 121. The pair of first electrodes 110 are disposed so as to sandwich electrode 120 such that material mixture layer 112 and second material mixture layer 122 face each other via separator 107.

From one side of first current collector 111, first tab 114 cut out from a conductive sheet material that is the same as that of first current collector 111 is extended. First tabs 114 of the pair of first electrodes 110 are stacked to each other and electrically connected to each other by, for example, welding. Thus, assembly tab 114A is formed. To assembly tab 114A, first lead 113 is connected. First lead 113 is drawn out to the outside of exterior body 108.

Similarly, from one side of second current collector 121, second tab 124 cut out from a conductive sheet material that is the same as that of second current collector 121 is extended. To second tab 124, second lead 123 is connected. Second lead 123 is drawn out to the outside of exterior body 108.

End portions of first lead 113 and second lead 123 derived to the outside of film exterior body 108 serves as a positive external terminal or a negative external terminal. It is desirable that sealing material 130 be interposed between exterior body 108 and each lead in order to enhance the sealing property. For sealing material 130, a thermoplastic resin can be used.

A method for producing nonaqueous electrolyte secondary battery 100 is not particularly limited, but nonaqueous electrolyte secondary battery 100 can be produced by, for example, the following procedures. Firstly, belt-like film exterior body 108 is prepared, belt-like film exterior body 108 is folded into two with the seal layer facing the inside, and both ends of belt-like film exterior body 108 are stacked to each other and welded into a tubular shape. Next, an electrode assembly is inserted from one opening of tubular exterior body 108, and then the opening is closed by thermal welding. At this time, from one opening of the tubular exterior body, end portions of first lead 113 and second lead 123 are derived, and sealing material 130 is interposed between the opening end portion and each lead. Thus, film exterior body 108 become an envelope shape of a bag shape. Next, from the remaining opening of envelope film exterior body 108, an electrolyte is injected, and then, the remaining opening is closed by thermal welding under reduced pressure. Thus, a flexible battery is completed.

Next, in a battery (flexible battery) as an example in which a positive electrode and a negative electrode are electrodes in sheet form including a material mixture layer formed on a current collector, and a battery case is a film exterior body, main members constituting an electrode assembly and a nonaqueous electrolyte, and the like, are described.

Positive Electrode

The positive electrode includes a positive current collector as a first or second current collector, and a positive electrode material mixture layer as a first or second active material layer. For the positive current collector, a metal film, a metal foil (a stainless steel foil, an aluminum foil, or an aluminum alloy foil), and the like, are used.

The positive electrode material mixture layer includes a positive electrode active material and a binder, and includes a conductive agent as necessary. The positive electrode active material is not particularly limited, but lithium-containing composite oxide such as LiCoO₂ and LiNiO₂ can be used. A thickness of the positive electrode material mixture layer is preferably, for example, 1 to 300 μm.

Negative Electrode

The negative electrode includes a negative current collector as a first or second current collector, and a negative electrode material mixture layer as a first or second material mixture layer. For the negative current collector, a metal film, a metal foil, and the like, are used. Materials of the negative electrode current collector is preferably at least one selected from copper, nickel, titanium, and alloys thereof, as well as a stainless steel. A thickness of the negative electrode current collector is preferably, for example, 5 to 30 μm.

The negative electrode material mixture layer includes a negative electrode active material and a binder, and includes a conductive agent as necessary. Examples of the negative electrode active material include Li metal, metal or an alloy electrochemically reacting with Li, a carbon material (for example, graphite), silicon alloy, silicon oxide, and the like. A thickness of the negative electrode material mixture layer is preferably, for example, 1 to 300 μm.

For the conductive agent to be included in the material mixture layer of the positive electrode or the negative electrode, graphite, carbon black, and the like, are used. The amount of the conductive agent is, for example, 0 to 20 parts by mass with respect to 100 parts by mass of the active material. Furthermore, for the binder to be included in the material mixture layer of the positive electrode or the negative electrode, as mentioned above, the first resin and the second resin are used. The amount of the binder is preferably 3 to 5 parts by mass with respect to 100 parts by mass of the active material.

Separator

As the separator, a microporous membrane made of a resin or a non-woven fabric is preferably used. Preferable examples of the materials (resins) for the separator include polyolefin, polyamide, polyamide-imide, and the like. A thickness of the separator is preferably, for example, 8 to 30 μm. On the surface of the separator, in order to improve the adhesion to the electrode, a resin such as PVDF may be attached.

Nonaqueous Electrolyte

A nonaqueous electrolyte includes lithium salt and a nonaqueous solvent for dissolving lithium salt. Examples of the lithium salt include LiClO₄, LiBF₄, LiPF₆, LiCF₃SO₃, LiCF₃CO₂, imide salts, and the like. Examples of the nonaqueous solvent include cyclic carbonic acid esters such as propylene carbonate, ethylene carbonate, and butylene carbonate; chain carbonic acid esters such as diethyl carbonate, ethyl methyl carbonate, and dimethyl carbonate; and cyclic carboxylic acid esters such as γ-butyrolactone and γ-valerolactone.

Hereinafter, the present invention is described more specifically based on Examples. However, the following Examples are not construed to limit the scope of the present invention. Note here that in the Examples, a flexible battery having a structure shown in FIG. 1 is produced.

### Example 1

According to the following procedures, a flexible battery including a pair of negative electrodes and a positive electrode sandwiched between the positive electrodes is produced.

(1) Positive Electrode

One hundred parts by mass of lithium cobaltate as the positive electrode active material, 2 parts by mass of PVDF as a first resin of the binder, 2 parts by mass of styrene-(meth)acrylic ester copolymer (hereinafter, referred to as styrene-acrylate resin) as a second resin, and 1 part by mass of acetylene black as the conductive agent were used. These were stirred together with an appropriate amount of NMP in a kneader to prepare positive electrode material mixture paste having a solid content of 44% by mass. Note here that for the styrene-acrylate resin, a solid content obtained by volatilizing water from an aqueous emulsion (Polyzol LB-300 manufactured by Showa Denko K.K., solid content rate: 40%) including water as a dispersion medium. Furthermore, in all Examples and Comparative Examples, the similar aqueous emulsion was used.

As a positive current collector, a rolled aluminum foil having a thickness of 15 μm was prepared. The positive electrode material mixture paste was applied on both surfaces of the aluminum foil, dried at 100° C. for 30 seconds, and then rolled to form a 40-μm positive electrode material mixture layer on both surfaces of the positive current collector. Thereafter, heat treatment was carried out at 160° C. for two seconds to obtain a positive electrode sheet. From the positive electrode sheet, a positive electrode having a size of 21 mm×53 mm having a 5 mm×5 mm positive electrode tab was cut out, then the material mixture layer was peeled off from the positive electrode tab to expose an aluminum foil. Thereafter, a positive electrode lead made of aluminum was ultrasonically welded to the tip end of the positive electrode tab. For the positive electrode lead, a positive electrode lead covered with a sealing material made of a thermoplastic resin in a section to be welded to an exterior body.

(2) Negative Electrode

One hundred parts by mass of graphite as a negative electrode active material, and 4 parts by mass of PVDF as a binder were used. These were stirred together with an appropriate amount of NMP in a kneader to prepare negative electrode material mixture paste having a solid content of 54% by mass.

As the negative current collector, an electrolytic copper foil having a thickness of 8 μm was prepared. The negative electrode material mixture paste was applied on one surface of the electrolytic copper foil, dried at 105° C. for 30 seconds, and then rolled to form a 54-μm negative electrode material mixture layer on the one surface of the negative current collector. Thereafter, heat treatment was carried out at 160° C. for two seconds to obtain a negative electrode sheet. From the negative electrode sheet, a negative electrode having a size of 23 mm×55 mm having a 5 mm×5 mm negative electrode tab, then the material mixture layer was peeled off from the negative electrode tab to expose a copper foil. Thereafter, a pair of negative electrodes are disposed such that the material mixture layers face each other, and a copper negative electrode lead was ultrasonically welded to the tip end of the stacked negative electrode tabs. For the negative electrode lead, a negative electrode lead covered with a sealing material made of a thermoplastic resin in a section to be welded to an exterior body.

(3) Nonaqueous Electrolyte

A nonaqueous electrolyte was prepared by dissolving LiPF₆ in a mixed solvent of ethylene carbonate (EC), ethyl methyl carbonate (EMC), and diethyl carbonate (DEC) (volume ratio of 20:30:50) at a concentration of 1 mol/L.

(4) Film Exterior Body

A film exterior body (thickness: 75 μm) including a polyethylene (PE) film (thickness: 30 μm) as a seal layer, a rolled aluminum foil (thickness: 15 μm) as a gas barrier layer, and a PE film (thickness: 30 μm) as a protective layer was prepared.

(5) Separator

A polymer solution was prepared by dissolving 5 parts by mass of PVDF in 100 parts by mass of NMP. The polymer solution was applied to both surfaces of a separator made of a microporous polyethylene film (thickness: 9 μm) having a size of 23 mm×59 mm, and then vaporizing the solvent to obtain a separator on which PVDF was attached on the surface. The amount of applied PVDF was 15 g/m². Note here that when PVDF was attached to the surface of the separator, the electrode easily adheres to the separator, thus suppressing position displacement in the manufacturing.

(6) Assembling of Flexible Battery

A positive electrode and a pair of negative electrodes were disposed with a separator interposed between a negative electrode material mixture layer and a positive electrode material mixture layer via a separator to form an electrode assembly.

Next, the electrode assembly was housed in a cylindrically-shaped film exterior body with a seal layer facing the inside. The positive electrode lead and the negative electrode lead were derived from one opening of the film exterior body, and a sealing material of each lead was interposed into a welded portion with the film exterior body, and the opening was sealed by thermal welding.

Next, a nonaqueous electrolyte was injected from the other opening, and the other opening was thermally welded in a reduced pressure atmosphere of −650 mmHg. Thereafter, the battery was subjected to aging in an environment at 45° C., and the electrode assembly was impregnated with the nonaqueous electrolyte. Finally, the battery was pressed at a pressure of 0.25 MPa for 30 seconds at 25° C. to produce battery A1 having a thickness of 0.5 mm.

### Example 2

Positive electrode material mixture paste having a solid content of 53% by mass was prepared in the same manner as in Example 1 and flexible battery A2 was produced in the same manner as in Example 1 except that 9 parts by mass of an aqueous emulsion having a PVDF content of 22% by mass (2 parts by mass of PVDF) as the first resin and 5 parts by mass of an aqueous emulsion having a styrene-acrylate resin content of 40% by mass (2 parts by mass of styrene-acrylate resin) were used as the second resin, and further 1.2 parts by mass of carboxymethyl cellulose sodium salt was used as the thickener.

### Comparative Example 1

Flexible battery B1 was produced in the same manner as in Example 1 except that only 4 parts by mass of PVDF was used as the binder of the positive electrode material mixture paste.

### Comparative Example 2

Flexible battery B2 was produced in the same manner as in Example 2 except that only 18 parts by mass of an aqueous emulsion having a PVDF content of 22% by mass (4 parts by mass of PVDF) was used as a binder of the positive electrode material mixture paste.

### Comparative Example 3

Flexible battery B3 was produced in the same manner as in Example 2 except that only 10 parts by mass of an aqueous emulsion having a styrene-acrylate resin content of 40% by mass (4 parts by mass of styrene-acrylate resin) was used as the binder of the positive electrode material mixture paste.

### Example 3

### (1) Positive Electrode

One hundred parts by mass of lithium cobaltate as a positive electrode active material, and 4 parts by mass of PVDF as a binder were used. For a conductive agent, 1 part by mass of acetylene black was used. These were stirred together with an appropriate amount of NMP in a kneader to prepare positive electrode material mixture paste having a solid content of 44% by mass.

### (2) Negative Electrode

One hundred parts by mass of graphite as a negative electrode active material and 2 parts by mass of PVDF as a first resin of a binder were used. For a conductive agent, 2 parts by mass of styrene-acrylate resin was used. These were stirred together with an appropriate amount of NMP in a kneader to prepare negative electrode material mixture paste having a solid content of 53%.

Flexible battery A3 was produced in the same manner as in Example 1 except that the positive electrode paste and the negative electrode material mixture paste were changed to the above.

### Example 4

Negative electrode material mixture paste having a solid content of 53% by mass was prepared in the same manner as in Example 3, and flexible battery A4 was produced in the same manner as in Example 3 except that 9 parts by mass of an aqueous emulsion having a PVDF content of 22% by mass (2 parts by mass of PVDF) as the first resin of the binder of the negative material mixture paste, and 5 parts by mass of an aqueous emulsion having a styrene-acrylate resin content of 40% by mass (2 parts by mass of styrene-acrylate resin) as the second resin were used, and further 1.2 parts by mass of carboxymethyl cellulose sodium salt as the thickener was used.

### Comparative Example 4

Flexible battery B4 was produced in the same manner as in Example 3 except that only 4 parts by mass of PVDF was used as the binder of the negative electrode material mixture paste.

### Comparative Example 5

Flexible battery B5 was produced in the same manner as in Example 4 except that only 18 parts by mass of an aqueous emulsion having a PVDF content of 22% by mass (4 parts by mass of PVDF) was used as the binder of the negative electrode material mixture paste.

### Comparative Example 3

Flexible battery B6 was produced in the same manner as in Example 4 except that only 10 parts by mass of an aqueous emulsion having a styrene-acrylate resin content of 40% by mass (4 parts by mass of styrene-acrylate resin) was used as the binder of the negative electrode material mixture paste.

### Examples 5 to 8

Flexible batteries A5 to A8 were produced in the same manner as in Example 4 except that the amount of the styrene-acrylate resin was changed to 0.5 parts by mass (A5), 1 part by mass (A6), 3 parts by mass (A7), or 5 parts by mass (A8) by adjusting the use amount of an aqueous emulsion of styrene-acrylate resin as the second resin of the negative electrode material mixture paste.

[Evaluation]

### Peel Strength

An electrode test sample having a size of 1.5 cm×7 cm (electrode having a material mixture layer on one surface of the current collector) was prepared, and the material mixture surface was fixed to a base using a tape with the material mixture surface facing downward. Then, peel strength was measured at the time when one end of the current collector on the upper surface was picked up and raised at a rate of 24 mm/min. Note here that in the positive electrode, since an electrode plate is formed such that material mixture layers are formed on both surfaces, measurement was carried out after the material mixture on one surface had been removed.

(Bending Test)

A pair of expandable fixing members were disposed to face each other horizontally, and portions closed by thermal welding on both ends of a charged state battery were fixed by the fixing members. Then, in the environment of humidity of 65% at 25° C., a jig having a curved portion having a radius of curvature R of 20 mm was pressed against the battery to bend the battery along the curved surface. Then, the jig was separated from the battery to return the shape of the battery to the original shape. This operation was repeated. Every 1000 times of this operation, a battery voltage was measured and durable times until the material mixture fell off and an internal short circuit occurred in the battery was measured.

(1C Rate Characteristics)

Under an environment at 25° C., after a constant current and a constant voltage charging, 0.2C discharging was carried out, and the capacity (C₀₂) was measured. Next, after a constant current and a constant voltage charging, 1C discharging was carried out, and the capacity (C₁) was measured. Using each measured discharge capacity, the ratio of 1C discharge capacity to 0.2C discharge capacity (C₁/C₀₂) was determined as 1C rate characteristics. Note here that the charging/discharging conditions of the battery are as follows. Herein, the design capacity of the battery is 1C (mAh).

(1) Constant current charge: 0.2 CmA (final voltage: 4.35 V)

(2) Constant voltage charge: 4.35 V (final electric current: 0.05 CmA)

(3) Constant current discharge: 0.2 CmA (final voltage: 3.0 V) or 1 CmA (final voltage: 3.0 V)

### (Warping Test)

An electrode, in which a material mixture layer had been formed and rolled on only one surface of the current collector, was heated in air at 120° C. to 160° C. for 0.02 minutes to 1 minute. Thereafter, a warped electrode was disposed on a shape measuring device (VR3000, manufactured by Keyence) with the protruding side of the warped electrode facing upward, and a radius of curvature of the protruding portion of the electrode was measured. When the radius of curvature R was 150 mm or more, it was determined that warping was such an extent that it did not cause position displacement of the electrode and it was determined as (o), and otherwise it was determined as (x).

Ten batteries were prepared for each Example and Comparative Example, and the same test was performed for each battery. The results are shown in Tables 1 to 3.

TABLE 1

| | | Compar- | | Compar- | Compar- |
|---|---|---|---|---|---|
| | | ative | | ative | ative |
| | Example 1 | Example 1 | Example 2 | Example 2 | Example 3 |
| Positive | NMP | NMP | water | water | water |
| electrode | | | | | |
| material | | | | | |
| mixture | | | | | |
| dispersion | | | | | |
| medium | | | | | |
| Battery | A1 | B1 | A2 | B2 | B3 |
| Positive | PVDF | PVDF | PVDF | PVDF | — |
| electrode | 2 parts by | 4 parts by | 2 parts by | 4 parts by | |
| binder | mass | mass | mass | mass | |
| (first | | | | | |
| resin) | | | | | |
| Positive | styrene- | — | styrene- | — | styrene- |
| electrode | acrylate | | acrylate | | acrylate |
| binder | resin | | resin | | resin |
| (second | 2 parts by | | 2 parts by | | 4 parts by |
| resin) | mass | | mass | | mass |
| Peeling | 13 | 9 | 12 | 7 | 11 |
| strength | | | | | |
| (N/m) | | | | | |
| Bending | 20000 | 16000 | 20000 | 9000 | 16000 |
| test | | | | | |
| Durable | | | | | |
| times | | | | | |
| (times) | | | | | |
| 1C rate | 96% | 95% | 95% | 93% | 90% |
| property | | | | | |
| Warping of | ◯ | ◯ | ◯ | ◯ | X |
| electrode | ≥150 mm | ≥150 mm | ≥150 mm | ≥150 mm | 30 mm |
| Radius of | | | | | |
| curvature R | | | | | |

TABLE 2

| | | Compar- | | Compar- | Compar- |
|---|---|---|---|---|---|
| | | ative | | ative | ative |
| | Example 3 | Example 4 | Example 4 | Example 5 | Example 6 |
| Negative | NMP | NMP | water | water | water |
| electrode | | | | | |
| material | | | | | |
| mixture | | | | | |
| dispersion | | | | | |
| medium | | | | | |
| Battery | A3 | B4 | A4 | B5 | B6 |
| Negative | PVDF | PVDF | PVDF | PVDF | — |
| electrode | 2 parts by | 4 parts by | 2 parts by | 4 parts by | |
| binder | mass | mass | mass | mass | |
| (first | | | | | |
| resin) | | | | | |
| Negative | styrene- | — | styrene- | — | styrene- |
| electrode | acrylate | | acrylate | | acrylate |
| binder | resin | | resin | | resin |
| (second | 2 parts by | | 2 parts by | | 4 parts by |
| resin) | mass | | mass | | mass |
| Peeling | 13 | 8 | 12 | 6 | 12 |
| strength | | | | | |
| (N/m) | | | | | |
| Bending | 20000 | 15000 | 20000 | 10000 | 16000 |
| test | | | | | |
| Durable | | | | | |
| times | | | | | |
| (times) | | | | | |
| 1C rate | 95% | 94% | 94% | 93% | 88% |
| property | | | | | |
| Warping of | ◯ | ◯ | ◯ | ◯ | X |
| electrode | ≥150 mm | ≥150 mm | ≥150 mm | ≥150 mm | 30 mm |
| Radius of | | | | | |
| curvature R | | | | | |

TABLE 3

| | Example 5 | Example 6 | Example 3 | Example 7 | Example 8 |
|---|---|---|---|---|---|
| Solvent | water | water | water | water | water |
| Battery | A5 | A6 | A3 | A7 | A8 |
| Negative | PVDF | PVDF | PVDF | PVDF | PVDF |
| electrode | 2 parts | 2 parts | 2 parts | 2 parts | 2 parts |
| binder | by mass | by mass | by mass | by mass | by mass |
| (first | | | | | |
| resin) | | | | | |
| Negative | styrene- | styrene- | styrene- | styrene- | styrene- |
| electrode | acrylate | acrylate | acrylate | acrylate | acrylate |
| binder | resin | resin | resin | resin | resin |
| (second | 0.5 parts | 1 part | 2 parts | 3 parts | 5 parts |
| resin) | by mass | by mass | by mass | by mass | by mass |
| Peeling | 9 | 10 | 12 | 15 | 18 |
| strength | | | | | |
| (N/m) | | | | | |
| Bending | 18000 | 20000 | 20000 | 20000 | 20000 |
| test | | | | | |
| Durable | | | | | |
| times | | | | | |
| (times) | | | | | |
| 1C rate | 95% | 94% | 94% | 94% | 93% |
| property | | | | | |
| Warping of | ◯ | ◯ | ◯ | ◯ | ◯ |
| electrode | ≥150 mm | ≥150 mm | ≥150 mm | ≥150 mm | ≥150 mm |
| Radius of | | | | | |
| curvature | | | | | |
| R | | | | | |

From Tables 1 and 2, it is shown that when PVDF as the first resin and a styrene-acrylate resin as the second resin were used in combination as a binder, the peel strength is 9 N/m or more, and Durable times in the bending test was 18000 times or more. Furthermore, the 1C rate characteristics maintaining rate was 94% or more, and the warping (radius of curvature) R of the electrode was 150 or more. These effects were observed both in the positive electrode and the negative electrode. It is thought from these results that the first resins having a smaller particle size enter between the second resins having a large particle size, so that the first resin having high flexibility has a function of relieving the bending stress in the surrounding of the second resin. Thus, it is thought that the bending resistance of the electrode is remarkably improved. Furthermore, it is thought that the dispersibility of the binder inside the electrode becomes good, thereby improving the peel strength of the active material mixture.

Furthermore, from the results of Table 3, when the mass proportion of the second resin in the first resin is 50% to 150%, the peel strength is 10 N/m or more, and Durable times of the bending test is 20000 times, and the 1C rate characteristics maintenance rate is 94%, and warping (radius of curvature) R of an electrode plate is 150 mm or more. It is thought that the ranges are more preferable from the viewpoint of improvement of the warping of the electrode, peeling of an active material mixture, and the battery characteristics.

### Example 9

When the warping (radius of curvature) of the negative electrode when a heat treatment temperature was changed was measured using a negative electrode produced in the same manner as in Example 1 and having a negative electrode material mixture layer on one surface of the negative electrode current collector. In the heat treatment, the negative electrode was heated for two seconds at 23° C., 80° C., 100° C., 120° C., 140° C., or 160° C. A measurement method of the warping of the negative electrode is the same as mentioned above.

### Example 10

The warping (radius of curvature) of the negative electrode was measured in the same manner as in Example 9 except that the heat treatment time is changed to one hour.

Furthermore, the process defect rate was calculated. The process defect rate means the degree of occurrence of dimension defect. The process defect rate can be calculated from dimension distribution obtained at the time of measurement of warping (radius of curvature) of each negative electrode. Specifically, the flexible battery is assembled as in Example 1, then the electrode assembly is disassembled, and the negative electrode is observed. At this time, a press mark of an outline of the positive electrode remains on the surface of the negative electrode. The shortest dimension between the end portion in the longitudinal direction of the negative electrode and the press mark was measured, and the narrowest dimension was recorded. Dispersion σ was calculated from the dimension data (n=about 50), and probability (defect rate) smaller than a standard lower limit value assumed to be normal distribution (for example, 0.5 mm) is calculated.

The warping (radius of curvature) of the electrode as well as results of the process defect rate of Examples 9 and 10 are shown in Table 4.

TABLE 4

| | | Example 9 | | Example 10 | |
|---|---|---|---|---|---|
| | | Heat treatment time: | | Heat treatment time: | |
| | | 2 seconds | | 1 hour | |
| | | | Process | | Process |
| | | Warping | defect | Warping | defect |
| | | R (mm) | rate (%) | R (mm) | rate (%) |
| Heating | 23 | 12 | 50 | 12 | 50 |
| temperature | 80 | 30 | 10 | 150 | 1.00 |
| (° C.) | 100 | 50 | 1.00 | 180 | 0.01 |
| | 120 | 150 | 0.02 | 200 | 0.01 |
| | 140 | 180 | 0.01 | 200 | 0.01 |
| | 160 | 200 | 0.01 | 200 | 0.01 |

It is shown from Table 4 that when the heating temperature is 120° C. to 160° C., and heating time is two seconds, the warping, the radius of curvature, of the electrode becomes 150 mm or more, and the process defect rate was 0.02% or less. From these results, it is shown that heating temperature is 120° C. to 160° C., and heating time is two seconds.

### INDUSTRIAL APPLICABILITY

A nonaqueous electrolyte secondary battery according to the present invention is suitably used for applications that may be largely deformed, for example, power supplies of small electronic devices such as a biological wearable device or a wearable portable terminal.

1. A nonaqueous electrolyte secondary battery comprising:
a battery case; and
an electrode assembly and a nonaqueous electrolyte, housed in the battery case,
wherein the electrode assembly includes a positive electrode, a negative electrode, and a separator interposed between the positive electrode and the negative electrode,
at least one of the positive electrode and the negative electrode includes a material mixture layer including an active material and a binder, and a current collector holding the material mixture layer,
the binder contains a first resin and a second resin,
the first resin is a fluorocarbon resin, and
the second resin is a copolymer of a styrene monomer unit and a (meth)acrylic acid monomer unit.

2. The nonaqueous electrolyte secondary battery according to claim 1,
wherein an amount of the binder included in the material mixture layer is 3 to 5 parts by mass with respect to 100 parts by mass of the active material.

3. The nonaqueous electrolyte secondary battery according to claim 1, wherein an amount of the second resin with respect to 100 parts by mass of the first resin is 50 to 150 parts by mass.

4. The nonaqueous electrolyte secondary battery according to claim 1, wherein the fluorocarbon resin includes a vinylidene fluoride unit.

5. The nonaqueous electrolyte secondary battery according to claim 1, wherein the binder is included in at least the negative electrode.

6. The nonaqueous electrolyte secondary battery according to claim 1, wherein the electrode assembly is a laminate in a sheet form, including the positive electrode in a sheet form and the negative electrode in a sheet form with the separator interposed between the positive electrode and the negative electrode.

7. The nonaqueous electrolyte secondary battery according to claim 6, wherein the electrode assembly is laminated such that the negative electrode is disposed to each of both outer surfaces of the laminate in the sheet form.

8. The nonaqueous electrolyte secondary battery according to claim 1, having a thickness of 2 mm or less, wherein the battery case includes a film exterior body.

9. The nonaqueous electrolyte secondary battery according to claim 8, wherein in the negative electrode, a first surface of the current collector includes the material mixture layer, and a second surface of the current collector does not include the material mixture layer, the second surface facing an inner surface of the film exterior body.

10. A method for producing a nonaqueous electrolyte secondary battery, the method comprising:
producing a positive electrode and a negative electrode;
forming an electrode assembly including the positive electrode, the negative electrode, and a separator interposed between the positive electrode and the negative electrode; and
housing the electrode assembly together with a nonaqueous electrolyte into a battery case,
wherein at least one of the positive electrode and the negative electrode includes a material mixture layer including an active material and a binder, and a current collector holding the material mixture layer,
the binder includes a first resin and a second resin,
the first resin is a fluorocarbon resin, and
the second resin is a copolymer of a styrene monomer unit and a (meth)acrylic acid monomer unit, and
the method further comprising heating at least one of the positive electrode and the negative electrode.

11. The method according to claim 10, wherein the heating of at least one of the positive electrode and the negative electrode includes heating of the material mixture layer at a temperature of 120° C. to 160° C. for 0.02 minutes to 1 minute.

12. The method according to claim 10, wherein the fluorocarbon resin includes a vinylidene fluoride unit.

13. The method according to claim 10, wherein at least one of the positive electrode and the negative electrode is produced by allowing the current collector to hold paste including the binder, the active material, and water, followed by drying to form the material mixture layer, and then rolling the material mixture layer.
